(19) United States
(12) Patent Application Publication
(10) Pub. No.: US 2025/0223427 A1
(43) Pub. Date: Jul. 10, 2025

(54) RUBBER COMPOSITIONS AND ARTICLES THEREOF

(71) Applicant: The Goodyear Tire & Rubber Company, Akron, OH (US)

(72) Inventors: Eric Engeldinger, Redange-sur-Attert (LU); Marc Weydert, Bertrange (LU)

(21) Appl. No.: 18/408,157

(22) Filed: Jan. 9, 2024

(51) Int. Cl. C08L 9/06; B60C 1/00; C08C 19/02; C08K 3/36; C08K 5/548; C08K 9/06

(52) U.S. Cl. CPC C08L 9/06; B60C 1/0016; B60C 1/0025; C08C 19/02; C08K 3/36; C08K 5/548; C08K 9/06; C08K 2201/006

(57) ABSTRACT

In accordance with the purpose(s) of the present disclosure, as embodied and broadly described herein, the disclosure, in one aspect, relates to uncured compositions that include a partially saturated elastomer and pre-silanized silica. In some aspects, the uncured compositions include about 40 phr to about 200 phr of a pre-silanized silica and at least one partially saturated elastomer including repeat units, where greater than 15% to about 30% of all repeat units of the partially saturated elastomer include a double bond. Also disclosed are vulcanized rubber compositions including the uncured compositions that have been vulcanized and articles including tires and/or components of tires comprising the vulcanized rubber compositions.

### BACKGROUND

The demand for improved tire performance has resulted in the development and evaluation of new materials that have desired properties such as good stiffness and rolling resistance. In tire elastomer compositions, improving rolling resistance usually comes at the cost of reducing the stiffness of the composition. Improving properties such as rolling resistance and tensile strength while maintaining a balance in tradeoffs is challenging. There is a need for elastomer compositions for tires that can provide good rolling resistance as well as good tensile strength, while at the same time maintaining desired stiffness of the material.

### SUMMARY

In accordance with the purpose(s) of the present disclosure, as embodied and broadly described herein, the disclosure, in one aspect, relates to uncured compositions that include a partially saturated elastomer and pre-silanized silica. In some aspects, the uncured compositions include about 40 phr to about 200 phr of a pre-silanized silica and at least one partially saturated elastomer including repeat units, where greater than 15% to about 30% of all repeat units of the partially saturated elastomer include a double bond. Also disclosed are vulcanized rubber compositions including the uncured compositions after vulcanization and articles including tires and/or components of tires made from or including the vulcanized rubber compositions.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an,” and “the” include plural referents unless the context clearly dictates otherwise. Thus, for example, reference to “an elastomer,” “a pre-silanized silica,” or “a vulcanizing agent,” include, but are not limited to, mixtures or combinations of two or more such elastomers, pre-silanized silicas, or vulcanizing agents, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used herein, the term “phr” refers to parts by weight of a respective material per 100 parts by weight of rubber or elastomer. In general, using this convention, an elastomer composition is comprised of 100 parts by weight of rubber/elastomer. The claimed composition may comprise other rubbers/elastomers than explicitly mentioned in the claims, provided that the phr value of the claimed rubbers elastomers is in accordance with claimed phr ranges and the amount of all rubbers/elastomers in the composition results in total in 100 parts of rubber.

The terms “rubber” and “elastomer” may be used herein interchangeably, unless indicated otherwise.

As used herein, the “glass transition temperature” or “T_{g}”, of an elastomer or rubber represents the glass transition temperature(s) of the respective elastomer or rubber in its uncured state or, in the case of an elastomer composition, in some aspects, T_{g} can be measured in a cured state.

As used herein, the term “uncured composition” refers to a composition including at least one natural or synthetic rubber component and, optionally, one or more fillers, processing aids, or additional compounds, that has not been vulcanized. Uncured rubber is sensitive to changes in temperature and has a tendency to undergo “cold flow” (slow movement or deformation under stress) over time. In some aspects, the uncured rubber composition is a masterbatch.

As used herein, the term “vulcanized rubber composition” refers to a rubber composition obtained by taking an uncured composition as described herein and curing or vulcanizing it, often accomplished using sulfur compounds and/or other curing additives and in the presence of heat. Vulcanized or cured rubber does not undergo cold flow and is less sensitive to changes in temperature relative to uncured rubber. In another aspect, rubber compositions can be cured in molds in order to form finished articles including, but not limited to, tires.

As used herein, the term “repeat unit” as referenced in the partially saturated elastomers described herein are derived from monomers used to produce the partially saturated elastomers. For example, polybutadiene has the repeat unit as provided below.

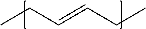

In certain aspects, when the partially saturated elastomer is the polymerization product of two different monomers (e.g., A and B), the repeat unit can be represented by -A-B-.

Unless otherwise specified, pressures referred to herein are based on atmospheric pressure (i.e. one atmosphere).

### Rubber Compositions

It has been discovered that the combination of a partially saturated elastomer having an increased number of double bonds with a pre-silanized silica results in an unexpected improvement in stiffness and hysteresis. Additionally, the use of the partially saturated elastomers described herein also improve tensile strength.

The uncured compositions, such as uncured rubber compositions, described herein include a partially saturated elastomer and pre-silanized silica. In some aspects, the uncured compositions include about 40 phr to about 200 phr of a pre-silanized silica and at least one partially saturated elastomer including repeat units, where greater than 15% to about 30% of all repeat units of the partially saturated elastomer include a double bond. Also disclosed herein are vulcanized rubber compositions including the uncured compositions that have been vulcanized and articles including tires and/or components of tires made from or including the vulcanized rubber compositions. The vulcanized or cured compositions have good rolling resistance and tensile strength with little to no decrease in stiffness compared to cured compositions that do not contain pre-silanized silica.

In some aspects, the partially saturated elastomer includes repeat units where greater than 15% to about 30% of all repeat units include a double bond. In other aspects, the amount of repeat units that include a double bond can be about 16%, 17%, 18%, 19%, 20%, 21%, 22%, 23%, 24%, 25%, 26%, 27%, 28%, 29%, or 30%, where any value can be a lower and upper endpoint of a range (e.g., 16% to 25%). When counting double bonds, the double bonds in an aromatic structure or group, such as those present in a styrene repeat unit, are not included in the count. However, a styrene unit is still counted as a repeat unit for the determination of the total number of repeat units in an elastomer.

In one aspect, the partially saturated elastomer can comprise repeat units formed by residues of monomers selected from one or more of ethylene, propylene, butadiene, isoprene, styrene, and any combination thereof. In further aspects, the partially saturated elastomer is a hydrogenated styrene butadiene rubber, in some aspects a hydrogenated solution-polymerized styrene butadiene rubber (SSBR). The hydrogenated styrene butadiene rubber can have a styrene content from about 5 wt % to about 40 wt %, or about 5 wt %, 10 wt %, 15 wt %, 20 wt %, 25 wt %, 30 wt %, 35 wt %, or 40 wt %, where any value can be a lower and upper endpoint of a range (e.g., 20 wt % to 40 wt %), and a butadiene content from about 60 wt % to about 95 wt %, or about 60 wt %, 65 wt %, 70 wt %, 75 wt %, 80 wt %, 85 wt %, 90 wt %, or 95 wt %, where any value can be a lower and upper endpoint of a range (e.g., 75 wt % to 90 wt %). In some aspects, an SSBR can be referred to as a partially hydrogenated SSBR (HSBR) when greater than 15% to about 30% of all repeat units of the SSBR include a double bond.

In other aspects, HSBR can be characterized as having about 16%, 17%, 18%, 19%, 20%, 21%, 22%, 23%, 24%, 25%, 26%, 27%, 28%, 29%, or 30%, where any value can be a lower and upper endpoint of a range (e.g., 18% to 23%), of all repeat units include a double bond. HSBR can also be characterized by having a weight average molecular weight (Mw) from about 100 kg/mol to about 4,000 kg/mol, or 100 kg/mol, 200 kg/mol, 300 kg/mol, 400 kg/mol, 500 kg/mol, 600 kg/mol, 700 kg/mol, 800 kg/mol, 900 kg/mol, 1,000 kg/mol, 1,100 kg/mol, 1,200 kg/mol, 1,300 kg/mol, 1,400 kg/mol, 1,500 kg/mol, 2,000 kg/mol, 3,000 kg/mol, or 4,000 kg/mol where any value can be a lower and upper endpoint of a range (e.g., 600 kg/mol to 900 kg/mol). In a further aspect, HSBR can be characterized by having a polydispersity index (Mw/Mn, Mn being the number average molecular weight) of about 1.05 to about 2.0 or 1.2, 1.4, 1.6, 1.8, or 2.0, where any value can be a lower and upper endpoint of a range (e.g., 1.4 to 1.8). Molecular weight parameters can be determined via gel permeation chromatography according to ASTM 5296-11 using polystyrene calibration standards, or an equivalent. In other aspects, HSBR can have a glass transition temperature from about −70° C. to about −20° C., or about −70° C., −60° C., −50° C., −40° C., −30° C., or −20° C., where any value can be a lower and upper endpoint of a range (e.g., −60° C. to −40° C.).

A partially saturated elastomer, in some aspects HSBR, can be obtained by hydrogenating an elastomer. A method for hydrogenating an elastomer can be performed by any methods known in the art. In one aspect, hydrogenation is performed by blowing aqueous hydrogen into an elastomer or polymer solution in the presence of a catalyst, such as a heterogeneous catalyst, a homogeneous catalyst, a catalyst using metallocene, such as titanocene, or any combination thereof. Examples of heterogenous catalysts include a catalyst containing a noble metal supported on a porous inorganic substance. Examples of homogenous catalysts include a catalyst obtained by reacting a solubilized salt of nickel, cobalt, or the like with organic aluminum or the like. The extent of hydrogenation in the resulting elastomer can be controlled by varying factors such as the amount of hydrogen added, the pressure of the hydrogen, the reaction time, the reaction temperature, the amount of catalyst added, the polymer solution viscosity, or any combination thereof. In some aspects, the hydrogenation reaction is carried out at a temperature of from about 60° C. to 105° C. or about 60° C., 70° C., 80° C., 90° C., 100° C., or 105° C., where any value can be a lower and upper endpoint of a range (e.g., 70° C. to 100° C.). In some aspects, the hydrogenation reaction is carried out as a batch process, a continuous process, or a combination thereof. Additional details regarding the production of partially saturated elastomers are described in United States Patent Application Publication US 2023/0138073 A1 and European Patent Application Publication EP 4261234 A1 and are incorporated herein by reference.

In other aspects, the compositions described herein can comprise from about 40 phr to about 200 phr of a pre-silanized silica. In other aspects, the composition can comprise from about 80 phr to about 130 phr of a pre-silanized silica or about 40 phr, 60 phr, 80 phr, 100 phr, 130 phr, 160 phr, 190 phr, or 200 phr, where any value can be a lower and upper endpoint of a range (e.g., 100 phr to 160 phr). In some aspects, the pre-silanized silica has a BET surface area from about 70 g/m² to about 200 g/m² or about 70 g/m², 100 g/m², 130 g/m², 160 g/m², or 200 g/m², where any value can be a lower and upper endpoint of a range (e.g., 130 g/m² to 200 g/m²). In some aspects, the pre-silanized silica has a CTAB absorption surface area from about 120 g/m² to about 220 g/m² or about 120 g/m², 140 g/m², 160 g/m², 180 g/m², 200 g/m², or 220 g/m², where any value can be a lower and upper endpoint of a range (e.g., 140 g/m², to 200 g/m²).

In one aspect, the pre-silanized silica can include silica with an alkylsilane, an alkoxysilane, an organoalkoxysilyl polysulfide, or an organomercaptoalkoxysilane bonded to the silica. In other aspects, the pre-silanized silica includes a silica with a sulfur-containing silane bonded to the silica. In one aspect, the sulfur-containing silane can include an alkoxyorganomercaptosilane or a bis(3-triethoxysilylpropyl) polysulfide, with an average of about 2 to 5 connecting sulfur atoms in its polysulfidic bridge. Examples of pre-silanized silicas suitable for use in the compositions described herein include, but are not limited to, Ciptane® 255 LD and Ciptane® LP (PPG Industries); silicas that have been pre-treated with a mercaptosilane; Coupsil® 8113 (Degussa); Coupsil® 6508; and Agilon® 400, 454, and 458 silica from PPG Industries.

In some aspects, the pre-silanized silica is treated with a silica dispersing aid. Such silica dispersing aids may include glycols, such as fatty acids, diethylene glycols, polyethylene glycols, fatty acid esters of hydrogenated or non-hydrogenated C5 or C6 sugars, and polyoxyethylene derivatives of fatty acid esters of hydrogenated or non-hydrogenated C5 or C6 sugars. Exemplary fatty acids include stearic acid, palmitic acid and oleic acid. Exemplary fatty acid esters of hydrogenated and non-hydrogenated C5 and C6 sugars (e.g., sorbose, mannose, and arabinose) include, but are not limited to, the sorbitan oleates (such as sorbitan monooleate, dioleate, trioleate, and sesquioleate) as well as sorbitan esters of laurate, palmitate, and stearate fatty acids. Exemplary polyoxyethylene derivatives of fatty acid esters of hydrogenated and non-hydrogenated C5 and C6 sugars include, but are not limited to, polysorbates and polyoxyethylene sorbitan esters, which are analogous to the fatty acid esters of hydrogenated and non-hydrogenated sugars noted above except that ethylene oxide groups are placed on each of the hydroxyl groups. The silica dispersing aids can be present in amounts ranging from about 0.1 wt % to about 25 wt % based on the weight of the silica.

In other aspects, the pre-silanized silica is pre-hydrophobated by treating silica in an aqueous colloidal form thereof with both an organomercaptosilane and an alkylsilane in a weight ratio of from 10/90 to 90/10 (organomercaptosilane to alkylsilane). In some aspects, alkylsilane is represented by the general formula (I):

Xₙ—Si—R¹₄₋ₙ (I),

wherein R is an alkyl radical with 1 to 18 carbon atoms or from 1 to 8 carbon atoms (e.g., methyl, ethyl, butyl, etc.), n is from 1 to 3, and X is a radical selected from the halogens and alkoxy radicals. In some aspects, X is chlorine or bromine. In other aspects, X is an alkoxy radical such as (R²O)—, wherein R² is an alkyl radical having from 1 to 3 carbon atoms. In some aspects, organomercaptosilane is represented by of the general formula (II):

(X)ₙ(R³O)₃₋ₙ—Si—R⁴—SH (II),

wherein X is a radical selected from the halogens and alkyl radicals having from 1 to 16 carbon atoms, R³ is an alkyl radical with 1 to 16 carbon atom or 1 to 4 carbon atoms, R⁴ is an alkylene radical with 1 to 16 carbon atoms or 1 to 4 carbon atoms (e.g., —(CH₂)ₘ— where m is 1 to 16), and n is from 0 to 3. In some aspects, X is chlorine or bromine. In other aspects, X is an alkyl radical selected from methyl, ethyl, n-propyl, and n-butyl radicals. In other aspects, R⁴ is a propylene radical. In some aspects, n is 0.

Representative alkylsilanes of formula (I) are trichloro methyl silane, dichloro dimethyl silane, chloro trimethyl silane, trimethoxy methyl silane, dimethoxy dimethyl silane, methoxy trimethyl silane, trimethoxy propyl silane, trimethoxy octyl silane, trimethoxy hexadecyl silane, dimethoxy dipropyl silane, triethoxy methyl silane, triethoxy propyl silane, triethoxy octyl silane, and diethoxy dimethyl silane. Representative organomercaptosilanes of Formula (II) are, for example, triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, and tripropoxy mercaptopropyl silane.

The uncured rubber composition can further include about 0.4 phr to about 15.0 phr of a vulcanizing agent, or about 0.4 phr, 3.0 phr, 6.0 phr, 9.0 phr, 12.0 phr, or 15.0 phr, where any value can be a lower and upper endpoint of a range (e.g., 9.0 phr to 12.0 phr). In some aspects, the vulcanizing agent includes elemental sulfur, a sulfur-containing silane, or a combination thereof. Additionally, the uncured rubber composition can further include a vulcanizing accelerator. Vulcanizing accelerators can be preferably but not necessarily used to control the time and/or temperature required for vulcanization and to improve the properties of a vulcanized composition. The amount of vulcanizing accelerator in the composition can be in the amount of about 0.3 phr to about 4.0 phr, or 0.3 phr, 1.0 phr, 2.0 phr, 3.0 phr, or 4.0 phr, where any value can be a lower and upper endpoint of a range (e.g., 1.0 phr to 2.0 phr).

In some aspects, the vulcanizing accelerator includes a dithiocarbamate accelerator, a thiuram accelerator, a diphenylguanidine accelerator, a benzothiazole sulfenamide accelerator, or a combination thereof. The potential vulcanizing accelerator compounds can include derivatives, e.g., a benzothiazole sulfenamide accelerator includes benzothiazole sulfenamide and can also include derivatives of benzothiazole sulfenamide. In other aspects, the vulcanizing accelerator includes amines, disulfides, guanidines, thioureas, thiazoles, thiurams, sulfenamides, dithiocarbamates and xanthates. In another aspect, the vulcanizing accelerator includes combinations of a primary and a secondary accelerator, where the secondary accelerator is used in smaller amounts, such as from 0.05 phr to 3.00 phr. In some aspects, the secondary accelerator is selected from a guanidine, a dithiocarbamate, or a thiuram. In addition, delayed action accelerators can be used which are not affected by normal processing temperatures but produce a satisfactory cure at ordinary vulcanization temperatures.

The uncured rubber composition can comprise additional components, such as an oil. In some aspects, the oil is a processing oil. The processing oil can be included in the composition as an extending oil typically used to extend elastomers. The processing oil can also be included in the elastomer composition by addition of the oil directly during rubber compounding. The processing oil used can include both an extending oil present in the elastomers and a process oil added during compounding. Suitable processing oils include, but are not limited to, various oils as are known in the art, including aromatic, paraffinic, naphthenic, vegetable oils, and low PCA oils, such as MES, TDAE, SRAE, and heavy naphthenic oils. Suitable low PCA oils may include those having a polycyclic aromatic content of less than 3% by weight as determined by the IP346 method. Procedures for the IP346 method can be found in Standard Test Methods for Analysis and Testing of Petroleum and Related Products and British Standard 2000 Parts, 2003, 62nd edition, published by the Institute of Petroleum, United Kingdom. Suitable TDAE oils are available as Tudalen SX500 from Klaus Dahleke KG, VivaTec 400 and VivaTec 500 from H&R Group, Enerthene 1849 from BP, and Extensoil 1996 from Repsol. The oils can be available as the oil alone or along with an elastomer in the form of an extended elastomer. Suitable vegetable oils include, for example, soybean oil, sunflower oil, and canola oil which are in the form of esters containing a certain degree of unsaturation.

Described herein are vulcanized rubber compositions, where any of the uncured rubber compositions described herein have been vulcanized. In some aspects, the vulcanized rubber compositions have improved tensile strength compared to a cured composition that does not include a pre-silanized silica. In further aspects, the tensile strength of the vulcanized compositions disclosed herein have a tensile strength that is from about 5% to about 20% greater than a cured composition that does not include a pre-silanized silica (as determined by ASTM D412), or about 5%, 10%, 15%, 20%, 25%, or 30%, where any value can be a lower and upper endpoint of a range (e.g., 10% to 15%).

In other aspects, the vulcanized rubber compositions can show little to no reduction in stiffness, and in some aspects an increase in stiffness, compared to a cured composition that does not include a pre-silanized silica. In further aspects, the vulcanized compositions disclosed herein have a stiffness G′ that is within about 10%, about 15%, or about 5% of a cured composition that does not include a pre-silanized silica, based on ASTM D5289 and where stiffness G′ is measured at a strain at 1%, 100° C., and a frequency of 1 Hz. The vulcanized compositions can also have a tangent delta that is about 10% to about 40% lower that the tangent delta of a cured composition that does not include a pre-silanized silica or about 10%, 15%, 20%, 25%, 30%, 35%, or 40%, where any value can be a lower and upper endpoint of a range (e.g., 10% to 35%) based on DIN 53513 and where tangent delta is measured at 6%, 30° C., and a frequency of 7.8 Hz.

### Preparation and Applications of Rubber Compositions

The compositions disclosed herein can be compounded by methods generally known in the rubber compounding art, such as mixing the partially saturated elastomer and pre-silanized silica with various vulcanizable constituent rubbers with various commonly used additive materials such as sulfur donors; curing aids, such as activators and retarders; processing additives, such as oils, resins (including tackifying resins), and plasticizers; fillers; pigments; fatty acids; zinc oxide; waxes; antioxidants; antiozonants; and peptizing agents. Zinc oxide can be included in amounts of about 1 phr to about 5 phr. Depending on the intended use of the vulcanizable and vulcanized material (rubbers), the additives mentioned above are selected and commonly used in conventional amounts. In some aspects, tackifier resins are included in amounts of about 0.5 phr to 10 phr or about 1 phr to 5 phr. In some aspects, processing additives are included in amounts of about 1 phr to 50 phr. In some aspects, antioxidants are included in amounts of about 1 phr to 5 phr. Representative antioxidants include, but are not limited to, diphenyl-p-phenylenediamine and others, such as those disclosed in The Vanderbilt Rubber Handbook (1978), Pages 344 through 346. In some aspects, antiozonants are included in amounts of about 1 phr to 5 phr. Representative antiozonants include, but are not limited to, N-phenyl-N′-(1,3-dimethylbutyl)-p-phenylenediamine (6PPD) and N,N′-dixylene-p-phenylenediamine (DTPD). In some aspects, fatty acids are included in amounts of about 0.5 phr to 3 phr. Examples of fatty acids used includes stearic acid. In some aspects, waxes are included in amounts of about 1 phr to 5 phr. Microcrystalline waxes can be used. In some aspects, peptizers are included in amounts of about 0.1 phr to 1 phr. Typical peptizers include, for example, pentachlorothiophenol and dibenzamidodiphenyl disulfide.

The compositions disclosed herein can be mixed by methods known in the rubber mixing art. For example, the ingredients may be typically mixed in at least two stages, namely, at least one nonproductive stage followed by a productive mix stage. In some aspects, the mixing of the uncured composition comprises only a single nonproductive stage. The final curatives including vulcanizing agents may be typically mixed in the final stage which is conventionally called the “productive” mix stage in which the mixing typically occurs at a temperature, or ultimate temperature, lower than the mix temperature(s) of the preceding nonproductive mix stage(s). In an embodiment, the elastomer composition may be subjected to a thermomechanical mixing step.

The thermomechanical mixing step generally comprises a mechanical working in a mixer or extruder for a period of time, for example suitable to produce a rubber temperature which is within the range of about 140° C. to 190° C. The appropriate duration of the thermomechanical working varies as a function of the operating conditions, and the volume and nature of the components. For example, the thermomechanical working may be from about 1 to 20 minutes.

This disclosure also provides for articles that incorporate any of the vulcanized rubber compositions disclosed herein. In some aspects, the article comprises a tire, such as a pneumatic tire, or a component of a tire. The tire can be a race tire, passenger tire, aircraft tire, agricultural, earthmover, off-the-road, truck tire, or the like. In one aspect, the tire is a passenger or truck tire. The tire can also be a radial or bias. The component of the tire can be a tread, base, sidewall, apex, chafer, sidewall insert, wirecoat, innerliner, or any combination thereof. In another aspect, the component of the tire including the composition is a tread, base, sidewall, or any combination thereof. Vulcanization of the disclosed tires is generally carried out at conventional temperatures ranging from about 100° C. to about 200° C. or from about 110° C. to about 180° C. Such tires can be built, shaped, molded and cured by various methods which are known and will be readily apparent to those having skill in such art.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered Aspects, which should not be confused with the claims.
Aspect 1. An uncured composition comprising:
at least one partially saturated elastomer comprising repeat units, wherein greater than 15% to about 30% of all repeat units of the partially saturated elastomer comprise a double bond, and
about 40 phr to about 200 phr of a pre-silanized silica.
Aspect 2. The composition of aspect 1, wherein about 16% to about 25% of all repeat units of the partially saturated elastomer comprise a double bond.
Aspect 3. The composition of aspect 1 or 2, wherein the partially saturated elastomer comprises repeat units formed by residues of monomers selected from one or more of ethylene, propylene, butadiene, isoprene, styrene, and any combination thereof.
Aspect 4. The composition of aspect 1 or 2, wherein the partially saturated elastomer is a partially hydrogenated styrene butadiene rubber.
Aspect 5. The composition of aspect 4, wherein the partially hydrogenated styrene butadiene rubber has from about 16% to about 25% repeat units comprising a double bond.
Aspect 6. The composition of aspects 4 or 5, wherein the partially hydrogenated styrene butadiene rubber has a styrene content from about 5 wt % to about 40 wt % of the partially hydrogenated styrene butadiene rubber and a butadiene content from about 60 wt % to about 95 wt % of the partially hydrogenated styrene butadiene rubber.
Aspect 7. The composition of any one of aspects 4-6, wherein the partially hydrogenated styrene butadiene rubber has a glass transition temperature from about −70° C. to about −20° C.
Aspect 8. The composition of any one of aspects 4-7, wherein the hydrogenated styrene butadiene rubber has a weight average molecular weight from about 100 kg/mol to about 4000 kg/mol.
Aspect 9. The composition of any one of aspects 4-7, wherein the partially hydrogenated styrene butadiene rubber has an average molecular weight from about 100 kg/mol to about 1500 kg/mol.
Aspect 10. The composition of any one of aspects 1-9, wherein the composition comprises from about 80 phr to about 130 phr of the pre-silanized silica.
Aspect 11. The composition of any one of aspects 1-10, wherein the pre-silanized silica has a BET surface area from about 70 g/m² to about 200 g/m².
Aspect 12. The composition of any one of aspects 1-11, wherein the pre-silanized silica has a CTAB adsorption surface area from about 120 g/m² to about 220 g/m².
Aspect 13. The composition of any one of aspects 1-12, wherein the pre-silanized silica comprises silica with an alkylsilane, an alkoxysilane, an organoalkoxysilyl polysulfide, or an organomercaptoalkoxysilane bonded to the silica.
Aspect 14. The composition of any one of aspects 1-12, wherein the pre-silanized silica comprises a silica with a sulfur-containing silane bonded to the silica.
Aspect 15. The composition of aspect 14, wherein the sulfur-containing silane comprises a bis(3-triethoxysilylpropyl) polysulfide, comprising an average of about 2 to 5 connecting sulfur atoms in its polysulfidic bridge, or an alkoxyorganomercaptosilane.
Aspect 16. The composition of any one of aspects 1-15, wherein the composition further comprises a vulcanizing agent in the amount of 0.4 phr to 15.0 phr.
Aspect 17. The composition of aspect 16, wherein the vulcanizing agent comprises elemental sulfur, a sulfur containing silane, or a combination thereof.
Aspect 18. The composition of any one of aspects 1-17, wherein the composition further comprises a vulcanizing accelerator in the amount of 0.3 phr to 4.0 phr.
Aspect 19. The composition of aspect 18, wherein the vulcanizing accelerator comprises a dithiocarbamate accelerator, a thiuram accelerator, a diphenylguanidine accelerator, a benzothiazole sulfenamide accelerator, or a combination thereof.
Aspect 20. A vulcanized rubber composition comprising the uncured composition of any one of aspects 1-19 that has been vulcanized.
Aspect 21. The composition of aspect 20, wherein the composition has a tensile strength that is from about 5% to about 20% greater than a cured composition that does not include pre-silanized silica as determined by ASTM D412.
Aspect 22. The composition of aspect 20 or 21, wherein the composition has a stiffness G′ at a strain at 1%, 100° C., and a frequency of 1 Hz based on ASTM D5289 that is within 10% of a cured composition that does not include pre-silanized silica.
Aspect 23. The composition of any one of aspects 20-22, wherein the composition has a tangent delta at 6%, 30° C., and a frequency of 7.8 Hz based on DIN 53513 that is about 10% to about 40% lower than the tangent delta of a cured composition that does not include pre-silanized silica.
Aspect 24. An article comprising the vulcanized rubber composition of any one of aspects 20-23.
Aspect 25. The article of aspect 24, wherein the article comprises a tire or a component of a tire.
Aspect 26. The article of aspect 25, wherein the component of the tire comprises a tread, base, sidewall, apex, chafer, sidewall insert, wirecoat, innerliner, or any combination thereof.
Aspect 27. The article of aspect 25, wherein the component of the tire comprises a tread, base, sidewall, or any combination thereof.

### EXAMPLES

The following examples are put forth so as to provide those of ordinary skill in the art with a complete disclosure and description of how the compounds, compositions, articles, devices and/or methods claimed herein are made and evaluated. These examples are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Rubber Compositions

Two elastomer compositions comprising a solution polymerized styrene butadiene rubber (SSBR)-based matrix are provided in Table 1. Most of the ingredients of the two compositions are the same. The most notable difference is that SSBR 2 contains a pre-silanized silica whereas SSBR 1 contains a comparable amount of a conventional silica, i.e., a non-pre-silanized silica.

The rheological properties of the SSBR 1 and SSBR 2 compositions are presented in Table 2. There is no change in tensile strength between the two compositions. The Tangent Delta value is reduced by about by about 14% in the composition containing the pre-silanized silica, an improvement compared to the composition containing the conventional silica. Since Tangent Delta can be considered a hysteresis indicator, this reduction also indicates that there would be a reduced rolling resistance in a tire comprising the vulcanized SSBR 2 composition compared to a tire comprising the vulcanized SSBR 1 composition. Unfortunately, the stiffness of the SSBR 2 composition is much less than that of the SSBR 1 composition, with G′ being reduced by about 34% in SSBR 2 compared to SSBR 1. The use of pre-silanized silica in an elastomer composition introduces this tradeoff (improved hysteresis for lower low-strain stiffness) due to improved silica dispersion. Although the reduced hysteresis is a positive result from the introduction of pre-silanized silica, the large decrease in stiffness could be problematic for many performance-oriented tire applications.

TABLE 1
SSBR Rubber Compositions

Amounts in phr

| Ingredient | SSBR 1 | SSBR 2 |
|---|---|---|
| SSBR¹ | 80 | 80 |
| PBD² | 20 | 20 |
| Plasticizing resin³ | 7 | 7 |
| Waxes | 1.5 | 1.5 |
| Oil⁴ | 10 | 5 |
| Processing aids⁵ | 3 | 3 |
| Stearic Acid | 3 | 3 |
| Silica⁶ | 80 | 0 |
| Pre-silanized silica⁷ | 0 | 90 |
| Silane 1⁸ | 7 | 0 |
| Zinc Oxide | 2.5 | 2.5 |
| Sulfur | 1.3 | 1.3 |
| Antidegradants⁹ | 3 | 3 |
| DPG¹⁰ | 2.9 | 0 |
| CBS¹¹ | 2.3 | 2.3 |
| Silane 2 on carbon black | 2 | 2 |
| carrier¹² | | |

¹Solution polymerized styrene butadiene rubber as SLR4602 from Trinseo
²Polybutadiene rubber as Budene ™ 1223 from Goodyear
³Polyterpene resin as Sylvatraxx 4150 from Kraton Chemical
⁴TDAE oil
⁵including glycerine monoesters of stearic acid and zinc soaps of fatty acids
⁶Precipitated silica as Zeosil ™ Premium 200MP from Solvay
⁷Pre-silanized, precipitated silica as Agilon ™ 400 from PPG Industries
⁸Bis-triethoxysilylpropyl disulfide as SI266 ™ from Evonik
⁹based on phenylenediamines
¹⁰Diphenylguanidine (accelerator)
¹¹N-cyclohexyl-2-benzothiazolesulfenamide (accelerator)
¹²50% bis-triethoxysilylpropyl tetrasulfide on 50% N330 carbon black carrier, as X50S from Evonik

TABLE 2
Rheological Properties

| Property | SSBR 1 | SSBR 2 |
|---|---|---|
| G′(1%), 1 Hz [MPa] ^{a} | 2.24 | 1.47 |
| Tangent Delta (6%), 30° C. ^{b} | 0.22 | 0.19 |
| Tensile Strength [MPa] ^{c} | 21.2 | 21.2 |

^{a} G′ has been obtained with an RPA 2000 ™ Rubber Process Analyzer of the company Alpha Technologies, based on ASTM D5289, at a strain of 1%, 100° C. and a frequency of 1 Hz
^{b} Tangent Delta has been obtained by a Metravib ™ instrument at 6% strain and 7.8 Hz based on DIN 53513, or equivalent, at a temperature of 30° C.
^{c} Tensile strength has been determined by an S2 dumbell test based on ASTM D412 or equivalent, tensile strength is stress at break

Two elastomer compositions comprising a partially hydrogenated SSBR (HSBR)-based matrix (approximately 77% hydrogenated) are provided in Table 3. Most of the ingredients of the two compositions are the same. The most notable difference is that HSBR 2 contains a pre-silanized silica whereas HSBR 1 contains a comparable amount of a conventional silica, i.e., a non-pre-silanized silica.

The rheological properties of the HSBR 1 and HSBR 2 compositions are presented in Table 4. Similar to SSBR 1 and 2, the Tangent Delta value is reduced in the composition containing the pre-silanized silica compared to the composition containing the conventional silica. However, in the HSBR compositions, the reduction in Tangent Delta is more significant (about 29%) when using pre-silanized silica. Also, the stiffness of the pre-silanized silica composition, HSBR 2, is much closer to that of HSBR 1, with G′ being reduced by less than 10%, compared to the change in stiffness going from SSBR 1 to SSBR 2. Surprisingly, the HSBR 2 composition also shows an increase in tensile strength compared to HSBR 1. Improving tensile strength is difficult to achieve while also improving hysteresis properties. HSBR 2 has good stiffness, good rolling resistance indicators, and good tensile strength.

TABLE 3
Exemplary Rubber Compositions

Amounts in phr

| Ingredient | HSBR 1 | HSBR 2 |
|---|---|---|
| Pre-Silanized Silica¹ | 0 | 90 |
| Silica² | 80 | 0 |
| TDAE Oil | 10 | 5 |
| Waxes | 1.5 | 1.5 |
| Stearic Acid | 3 | 3 |
| HSBR³ | 100 | 100 |
| Silane⁴ | 8 | 0 |
| Antidegradants⁵ | 3 | 3 |
| Zinc oxide | 2.5 | 2.5 |
| Sulfur | 1.1 | 1.1 |
| Primary accelerator⁶ | 2.5 | 2.5 |
| Secondary accelerator⁷ | 0.2 | 0.2 |
| DPG⁸ | 2.9 | 0 |

¹Pre-silanized, precipitated silica as Agilon ™ 400 from PPG Industries
²Precipitated silica as Zeosil ™ Premium 200MP from Solvay
³Partially hydrogenated SSBR (77% ± 3% butadiene hydrogenation)
⁴Bis-triethoxysilylpropyl disulfide as SI266 ™ from Evonik
⁵Phenylenediamine derivatives
⁶N-cyclohexyl-2-benzothiazolesulfenamide—CBS
⁷2-mercaptobenzothiazole—MBT
⁸Diphenylguanidine

TABLE 4
Rheological Properties

| Property | HSBR 1 | HSBR 2 |
|---|---|---|
| G′(1%), 1 Hz [MPa] ^{a} | 2.33 | 2.16 |
| Tangent Delta (6%), 30° C. ^{b} | 0.21 | 0.15 |
| Tensile Strength [MPa] ^{c} | 17.8 | 19.9 |

^{a} G′ has been obtained with an RPA 2000 ™ Rubber Process Analyzer of the company Alpha Technologies, based on ASTM D5289, at a strain of 1%, 100° C. and a frequency of 1 Hz
^{b} Tangent Delta has been obtained by a Metravib ™ instrument at 6% strain and 7.8 Hz based on DIN 53513, or equivalent, at a temperature of 30° C.
^{c} Tensile strength has been determined by an S2 dumbbell sample test based on ASTM D412 or equivalent, tensile strength is stress at break

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. An uncured composition comprising:
at least one partially saturated elastomer comprising repeat units, wherein greater than 15% to about 30% of all repeat units of the partially saturated elastomer comprise a double bond, and
about 40 phr to about 200 phr of a pre-silanized silica.

2. The composition of claim 1, wherein about 16% to about 25% of all repeat units of the partially saturated elastomer comprise a double bond.

3. The composition of claim 1, wherein the partially saturated elastomer comprises repeat units formed by residues of monomers selected from one or more of ethylene, propylene, butadiene, isoprene, styrene, and any combination thereof.

4. The composition of claim 1, wherein the partially saturated elastomer is a partially hydrogenated styrene butadiene rubber.

5. The composition of claim 4, wherein the partially hydrogenated styrene butadiene rubber has from about 15% to about 25% repeat units comprising a double bond.

6. The composition of claim 4, wherein the partially hydrogenated styrene butadiene rubber has a styrene content from about 5 wt % to about 40 wt % of the partially hydrogenated styrene butadiene rubber and a butadiene content from about 60 wt % to about 95 wt % of the partially hydrogenated styrene butadiene rubber.

7. The composition of claim 4, wherein the partially hydrogenated styrene butadiene rubber has a glass transition temperature from about −70° C. to about −20° C.

8. The composition of claim 4, wherein the partially hydrogenated styrene butadiene rubber has a weight average molecular weight from about 100 kg/mol to about 1500 kg/mol.

9. The composition of claim 1, wherein the composition comprises from about 80 phr to about 130 phr of the pre-silanized silica.

10. The composition of claim 1, wherein the pre-silanized silica has a BET surface area from about 70 g/m² to about 200 g/m².

11. The composition of claim 1, wherein the pre-silanized silica has a CTAB adsorption surface area from about 120 g/m² to about 220 g/m².

12. The composition of claim 1, wherein the pre-silanized silica comprises silica with an alkylsilane, an alkoxysilane, an organoalkoxysilyl polysulfide, or an organomercaptoalkoxysilane bonded to the silica.

13. The composition of claim 1, wherein the pre-silanized silica comprises a silica with a sulfur-containing silane bonded to the silica.

14. The composition of claim 13, wherein the sulfur-containing silane comprises a bis(3-triethoxysilylpropyl) polysulfide, comprising an average of about 2 to 5 connecting sulfur atoms in its polysulfidic bridge, or an alkoxyorganomercaptosilane.

15. The composition of claim 1, wherein the composition further comprises a vulcanizing agent in the amount of 0.4 phr to 15.0 phr.

16. The composition of claim 1, wherein the composition further comprises a vulcanizing accelerator in the amount of 0.3 phr to 4.0 phr.

17. A vulcanized rubber composition comprising the uncured composition of claim 1 that has been vulcanized.

18. An article comprising the vulcanized rubber composition of claim 17.

19. The article of claim 18, wherein the article comprises a tire or a component of a tire.

20. The article of claim 19, wherein the component of the tire comprises a tread, base, sidewall, or any combination thereof.
